(19) United States
(12) Patent Application Publication
(10) Pub. No.: US 2002/0161824 A1
(43) Pub. Date: Oct. 31, 2002

(54) Method for presentation of HTML image-map elements in non visual web browsers

(75) Inventor: Elliott Woodard Harris, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/844,393

(22) Filed: Apr. 27, 2001

(51) Int. Cl. G06F 15/16

(52) U.S. Cl. 709/202; 706/925

(57) ABSTRACT

A method, program and apparatus for rendering an image in an electronic document by means of a non-visual browser are provided. The invention comprises rendering an image area within a web page, wherein the image area is associated with a hypertext link to an image document which contains content for the image area. When the browser renders a requested web page containing the image area and/or receives a selection of the image area, it retrieves the header element of the image and non-visually renders the information contained within the header. This information might include a title and national language designation, as well as other information inserted into the header by the web author. Non-visual rendering may be audible or by means of tactile feedback. In addition, non-visual rendering methods may be used in conjunction with traditional visual rendering, depending on the needs of the user.

### CROSS REFERENCE TO RELATED APPLICATIONS

The present application is related to co-pending U.S. patent application Ser. No. ______ (IBM Docket No. AUS920010295US1) entitled “EDITING HTML DOM ELEMENTS IN WEB BROWSERS WITH NON-VISUAL CAPABILITIES” filed even date herewith. The content of the above mentioned commonly assigned, co-pending U.S. Patent applications are hereby incorporated herein by reference for all purposes.

### BACKGROUND OF THE INVENTION

1. Technical Field

The present invention relates to computer network environments and more specifically to non-visual presentation of electronic documents.

2. Description of Related Art

Information on the World Wide Web is typically made available by structuring the information into a visual presentation. Hyper Text Markup Language (HTML) is used by web authors to define the visual structure. The end user is presented with this information by viewing the information on a computer display, after the information has been rendered into a visual format by a web browser (e.g. Netscape Navigator or MS Internet Explorer).

Web sites of well established businesses and organizations make extensive use of visual images. A HTML MAP defines a set of sub-regions over the image area. Each region is called an AREA, and is defined by an AREA element within the MAP definition. Each AREA can be associated with an Internet Uniform Resource Locator (URL). When the end user performs a mouse click within an area defined by the MAP, the web browser will navigate the associated URL. This process works well for a sighted user who is accessing the web using a visual browser. However, this process is not accessible by people with vision impairments, nor is it accessible by users who do not have a visual display device available (e.g. while driving a car).

A variety of software products are becoming available which enable non-visual access to HTML pages. These products capture the web page content and then present an audible rendering of the web page. This is generally accomplished by using a text-to-speech (TTS) technology to read the textual content.

However, images with MAP-AREAs cannot be directly rendered by non-visual browsers and TTS technology, because there is no text. For example, the words that one is able to read in the navigation bar of a web page are actually pictures of printed text, and consequently, cannot be read by a screen reader. The screen reader only knows that there is an image, but does not know whether the image is a picture of the beach or a vase of flowers.

Prior art approaches to the problem involve either ignoring the image or simply announcing the fact that there is an image that contains MAP-AREAs. However, unless the web authors have provided “alt” text for non-image rendering, the hyperlinks cannot be accurately described. For example, IBM markets a non-visual browser called Home Page Reader V2.5. In this product, the MAP-AREAs are rendered by reading a portion of the URLs associated with the areas. Unfortunately, most URLs are coded for computer rather than human consumption and do not give a description of an image that the user can understand.

Therefore, it would be desirable to have a method for accessing hyperlink information on web page images by means of a non-visual device.

### SUMMARY OF THE INVENTION

The present invention provides a method, program and apparatus for the rendering of an image in an electronic document by means of a non-visual browser. The invention comprises rendering an image area within a web page, wherein the image area is associated with a hypertext link to an image document which contains content for the image area. When the browser renders a requested web page containing the image area and/or receives a selection of the image area, it retrieves the header element of the image and non-visually renders the information contained within the header. This information might include a title and national language designation, as well as other information inserted into the header by the web author. Non-visual rendering may be audible or by means of tactile feedback. In addition, non-visual rendering methods may be used in conjunction with traditional visual rendering, depending on the needs of the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented;

FIG. 4 depicts a block diagram of a browser program in accordance with a preferred embodiment of the present invention;

FIG. 5 depicts a pictorial diagram illustrating a navigation bar on a web page in accordance with the prior art; and

FIG. 6 depicts a flowchart illustrating prefetching in accordance with the present invention.

### DETAILED DESCRIPTION OF THE PREFERRED EMBODIMENT

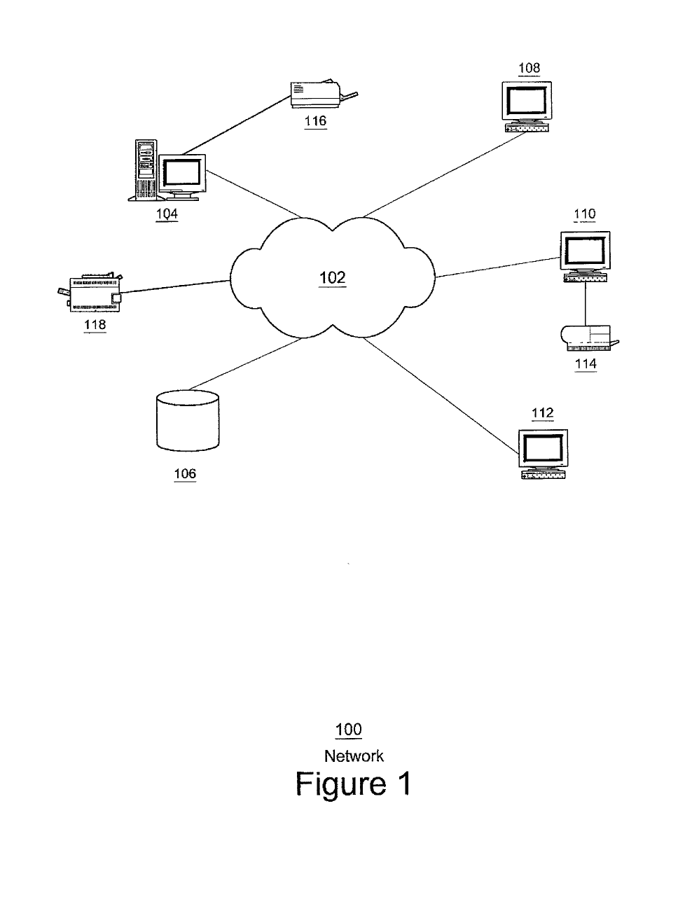

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

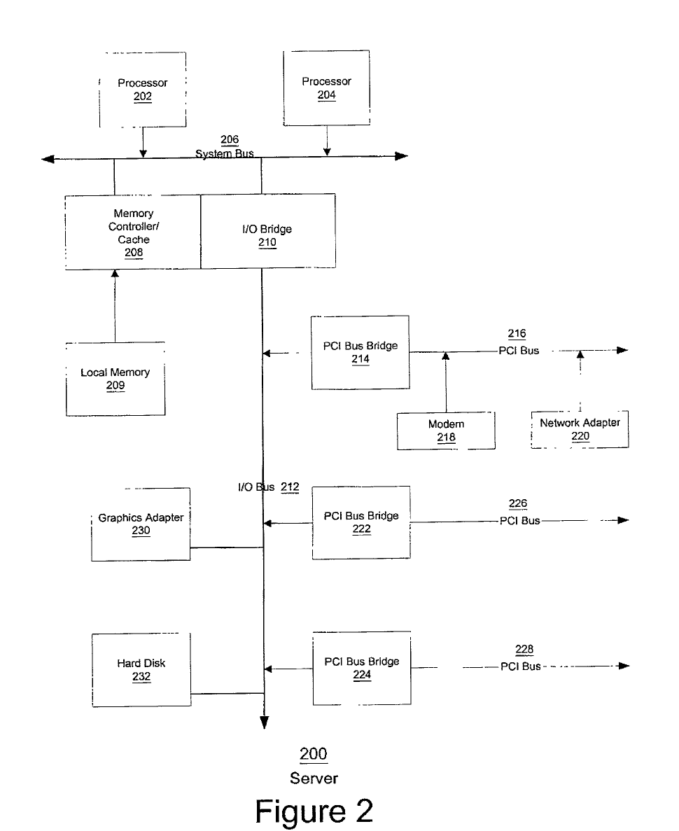

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

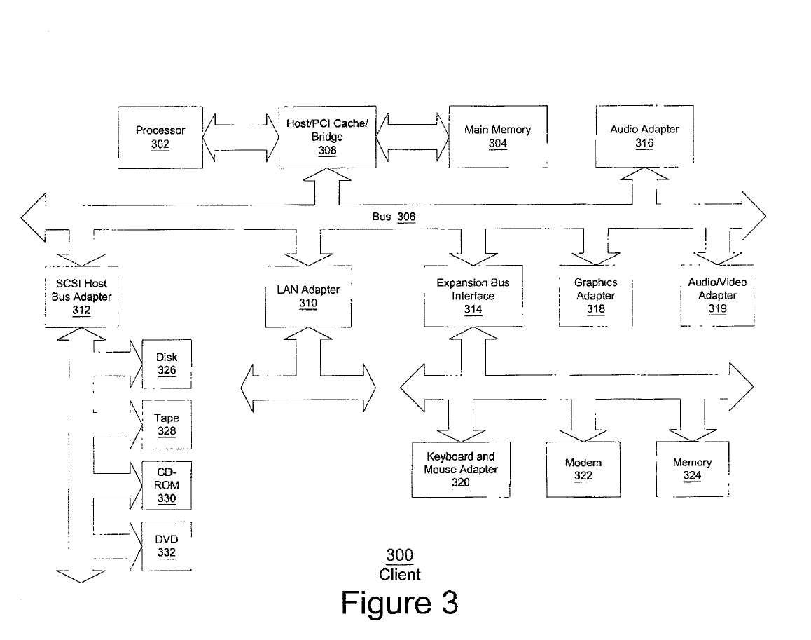

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

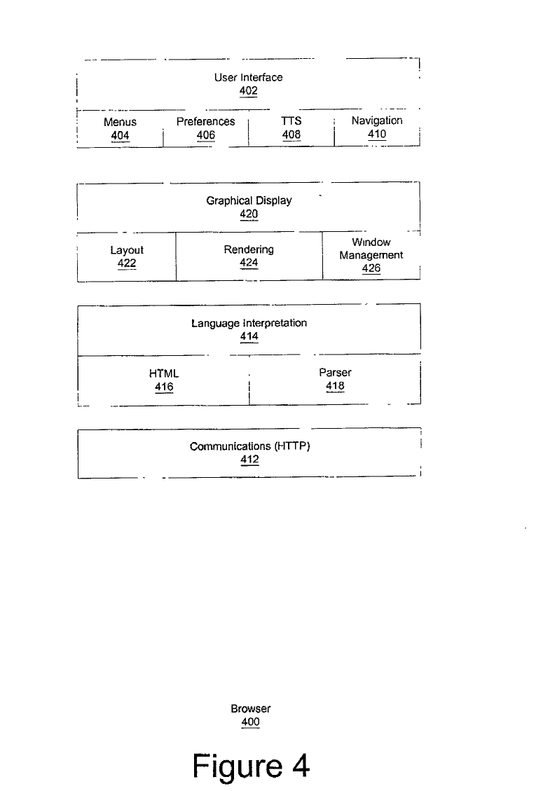

Turning next to FIG. 4, a block diagram of a browser program is depicted in accordance with a preferred embodiment of the present invention. Browser 400 includes a user interface 402, which is a graphical user interface (GUI) that allows the user to interface or communicate with browser 400. This interface provides for selection of various functions through menus 404 and allows for navigation through the navigation input 410. For example, menu 404 may allow a user to perform various functions, such as saving a file, opening a new window, displaying a history, and entering a URL. Navigation 410 allows for a user to navigate various pages and to select web sites for viewing. For example, navigation 410 may allow a user to see a previous page or a subsequent page relative to the present page. Navigation 410 may also have voice recognition capabilities. Preferences may be set through preferences 406. Browser 400 also contains text-to-speech (TTS) 408, which converts text data into auditory signals.

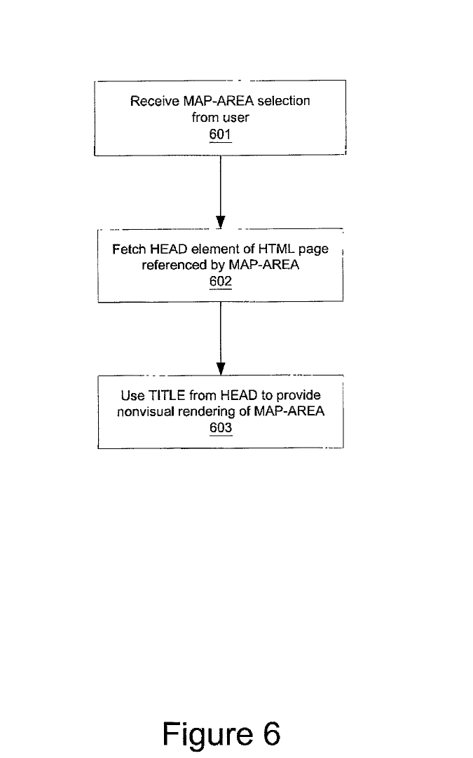

Communications 412 is the mechanism with which browser 400 receives documents and other resources from a network such as the Internet. Further, communications 412 is used to send or upload documents and resources onto a network. In the depicted example, communication 412 uses HTTP. However, other protocols are possible. Documents that are received by browser 400 are processed by language interpretation 414, which includes an HTML unit 416, and a parser 418 which is capable of generating a parse tree associated with an electronic document, as discussed below in reference to FIG. 6. Language interpretation 414 will process a document for presentation on graphical display 420. In particular, HTML statements are processed by HTML unit 416 for presentation.

Graphical display 420 includes layout unit 422, rendering unit 424, and window management 426. These units are involved in presenting web pages to a user based on results from language interpretation 414.

Browser 400 is presented as an example of a browser program in which the present invention may be embodied. Browser 400 is not meant to imply architectural limitations to the present invention. Presently available browsers may include additional functions not shown or may omit functions shown in browser 400. As used herein, the term “browser” encompasses any software application used to view or navigate for information or data (e.g. something that assists a user to browse) in a distributed data base where the distributed database is typically the internet or World Wide Web.

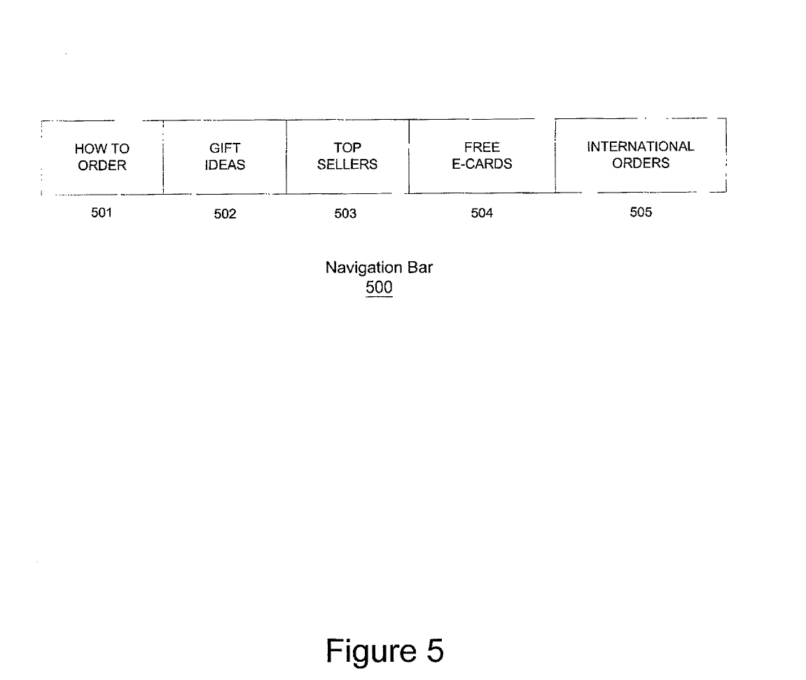

Referring now to FIG. 5, a pictorial diagram illustrating a navigation bar on a web page is depicted in accordance with the prior art. The navigation bar 500 contains several selections, including “How to Order” 501, “Gift Ideas” 502, and “International Orders” 505. Navigation bar 500 is actually a single MAP-AREA which is divided into five non-overlapping subregions 501-505. Each area 501-505 has an associated hypertext link to another web page. A mouse click over any of these areas 501-505 will take the user to the appropriate specialized catalog page.

This process works well for a sighted user who is accessing the web using a visual browser. However, this process is not accessible by people with vision impairments, nor is it accessible by users who do not have a visual display device available (e.g. while driving a car).

A variety of software products are becoming available which enable non-visual access to HTML pages. These products capture the web page content and then present an audible rendering of the web page. This is generally accomplished by using a text-to-speech (TTS) technology to read the textual content. However, images with MAP-AREAs cannot be directly rendered by non-visual browsers and TTS technology, because there is no text. Therefore, the contents of MAP-AREAs 501-505 in FIG. 5 cannot be rendered by prior art, non-visual browsers. In the prior art, MAP-AREAs are rendered by audibly reading a portion of the URLs referenced by the hypertext links associated with the MAP-AREAs. Unfortunately, most URLs are coded for computer rather than human consumption and do not give a description of an image that the user can understand. For example, the URL for the “How to Order” MAP-AREA 501 might be:

ref=gw tn ho rec/002-4815396-8524036

Accessing user friendly hypertext information on a web page image can be accomplished by prefetching the header information of the web pages that are referenced by MAP-AREA URLs. Then, instead of rendering the user unfriendly URL of the referenced page, the browser renders the more user friendly title (and possibly additional HEAD information).

Referring now to FIG. 6, a flowchart illustrating prefetching is depicted in accordance with the present invention. As noted in reference to FIG. 5, an image with a MAP-AREA can be associated with a hypertext link. Because non-visual browsers cannot directly render images, the present invention renders the content of an image indirectly by using the title of the web page referenced by an image.

The source text of an HTML page is divided into a HEAD section and a BODY section. When the browser receives a MAP-AREA selection from the user (step 601), it prefetches only the HEAD element of the HTML page referenced by the selected MAP-AREA, rather than the entire HTML page (step 602). The structure of HTML and HTTP protocols provides support for this approach, because facilities are provided for fetching only the information of interest.

The HEAD section contains the TITLE element, plus other information about the document, such as the national language in which the content is written (e.g. English, French German), as well as various user defined attributes, such as the web author's name. This HEAD content is typically only a few 10's or 100's of bytes, and may be fetched in as little as a single HTTP message.

The BODY section, in contrast, may be many 1000's of bytes, and may also require the download of other very large objects such as images. Many tens of messages, and hundreds of thousands of bytes, may be needed to download the entire page.

In order to describe the MAP-AREA, only the HEAD element of the HTML page needs to be fetched. HTTP already provides a feature to accomplish this task, in the current definition of the protocol (reference Internet Engineering Task Force (at http://www.ietf.org) document RFC 2616).

The browser can use the TITLE element within the HEAD to provide a non-visual rendering of the MAP-AREA content (step 603). For example, the title of the web page that is referenced by the “How to Order” MAP-AREA 501 might be “How to Order FAQ”. Instead of audibly rendering this web page by speaking the URL (i.e. “ref gw_tn_ho_rec/002-4814396-8524036”), the browser uses internet protocols to request the HEAD element of the web page referenced by the URL. Therefore, the browser will speak “How to Order FAQ” (the TITLE within the HEAD). In another embodiment, the browser can convey the information by means of a tactile feedback mechanism, rather than an audible one.

The present invention essentially creates a surrogate for image content by using the title of the web page referenced by that image.

Other information in the HEAD can also be used to provide additional information about the link in step 603. For example, the national language of the link could be provided. Additional attributes could be defined for the HEAD element, which are specifically designated for Accessibility purposes. These additional attributes would be tailored for impaired users, and provide information specifically designed to compensate for particular impairments (e.g. audible description of an image).

The prefetch could also be overlapped with other user activity. For example, when a user first arrives at a new web page, the non-visual browser could start to speak the title of that page, and concurrently, prefetch the first few titles of any MAP-AREAS referenced by that page. At local area network (LAN) speeds, assuming a responsive server, a dozen MAP-AREA titles could be perfected in the time required to speak the title of the parent page.

It should be pointed out that the techniques for non-visual rendering are not necessarily exclusive of traditional visual rendering techniques. Both visual and non-visual technology may be used in conjunction with each other, depending on the needs of the user.

It is important to note that while the present invention has been described in the context of a fully functioning data processing system, those of ordinary skill in the art will appreciate that the processes of the present invention are capable of being distributed in the form of a computer readable medium of instructions in a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for rendering an image area, associated with a hypertext link to an image document having content for the image area, contained within an electronic document, comprising:
retrieving a header element for the image document; and
rendering, non-visually, information contained within the header element;
when at least one of the following occur:
i) rendering a requested electronic document containing the image area, and
ii) receiving a selection of the image area.

2. The method according to claim 1, wherein the rendering is audible.

3. The method according to claim 1, wherein the rendering is by means of tactile feedback mechanism.

4. The method according to claim 1, wherein the information rendered from the header element of the second electronic document is a title.

5. The method according to claim 1, wherein the information rendered from the header element of the second electronic document is a national language designation.

6. The method according to claim 1, wherein the information rendered from the header element of the second electronic document comprises meta elements specified by the document author.

7. A method for receiving a rendering of an image area in an electronic document, comprising:
selecting an image area within a first electronic document, wherein the image area is associated with a hypertext link; and
receiving a rendering of information contained within a header element of a second electronic document, wherein the second electronic document is referenced by said hypertext link.

8. A method for receiving a rendering of an image area in an electronic document, comprising:
selecting a first electronic document having an image area, wherein the image area is associated with a hypertext link to a second electronic document;
receiving non-visual rendering information contained within the header element of the second electronic document in connection with a rendering of the first electronic document.

9. A computer program product in a computer readable medium for use in a data processing system, for rendering an image area, associated with a hypertext link to an image document having content for the image area, contained within an electronic document, comprising:
instructions for retrieving a header element for the image document; and
instructions for rendering, non-visually, information contained within the header element; when at least one of the following occur:
i) a requested electronic document is rendered containing the image area, and
ii) upon receipt of a selection of the image area.

10. A computer program product in a computer readable medium for use in a data processing system, for receiving a rendering of an image area in an electronic document, the computer program comprising:
instructions for enabling the selection of an image area within a first electronic document, wherein the image area is associated with a hypertext link; and
instructions for enabling the receipt of a rendering of information contained within a header element of a second electronic document, wherein the second electronic document is referenced by said hypertext link.

11. A computer program product in a computer readable medium for use in a data processing system. For receiving a rendering of an image area in an electronic document, the computer program comprising:
instructions for enabling the selection of a first electronic document having an image area, wherein the image area is associated with a hypertext link to a second electronic document;
instructions for enabling the receipt of non-visual rendering information contained within the header element of the second electronic document in connection with a rendering of the first electronic document.

12. A system for rendering an image area, associated with a hypertext link to an image document having content for the image area, contained within an electronic document, comprising:
a retrieval mechanism which retrieves a header element for an image document; and
a rendering component which non-visually renders information contained within the header element when at least one of the following occur:
i) a requested electronic document containing the image area is requested, and
ii) a selection of the image area is received.

13. The system according to claim 12, wherein the rendering is audible.

14. The system according to claim 12, wherein the information rendered from the header element of the second electronic document comprises meta elements specified by the document author.

15. A computer system for receiving a rendering of an image area in an electronic document, comprising:
means for enabling a selection of a first electronic document having an image area, wherein the image area is associated with a hypertext link to a second electronic document; and
means for enabling receipt of non-visual rendering information contained within a header element of the second electronic document in connection with a rendering of the first electronic document.

16. The computer system according to claim 15, wherein the rendering is by means of tactile feedback mechanism.

17. The computer system according to claim 15, wherein the information rendered from the header element of the second electronic document is a title.

18. The computer system according to claim 15, wherein the information rendered from the header element of the second electronic document is a national language designation.

19. A computer system for receiving a rendering of an image area in an electronic document, comprising:
means for enabling a selection of an image area within a first electronic document, wherein the image area is associated with a hypertext link; and
means for enabling receipt of non-visual rendering information contained within a header element of a second electronic document, wherein the second electronic document is referenced by said hypertext link.
